(19) United States
(12) Patent Application Publication
(10) Pub. No.: US 2020/0070724 A1
(43) Pub. Date: Mar. 5, 2020

(54) METHOD AND SYSTEM FOR AUTOMATICALLY DETECTING A COUPLING MANEUVER OF A TRANSPORTATION VEHICLE TO A TRAILER

(71) Applicant: VOLKSWAGEN AKTIENGESELLSCHAFT, Wolfsburg (DE)

(72) Inventor: Simon KRAFTSCHIK, Wolfenbüttel (DE)

(73) Assignee: Volkswagen Aktiengesellschaft

(21) Appl. No.: 16/555,462

(22) Filed: Aug. 29, 2019

(30) Foreign Application Priority Data
Sep. 4, 2018 (DE) 10 2018 214 973.9

(51) Int. Cl. B60R 1/00; G06K 9/00; H04N 7/18

(52) U.S. Cl. CPC B60R 1/00; G06K 9/00845; B60D 1/36; G06K 9/00791; H04N 7/183

(57) ABSTRACT

A method for the automatic detection of a maneuver for coupling a transportation vehicle to a trailer including displaying a rear vehicle environment detected by a rear-view camera of the transportation vehicle by a display device of the transportation vehicle; determining whether the driver is looking at the display device by using a viewing direction of a driver of the transportation vehicle detected by a detecting device of the transportation vehicle; and issuing a query as to whether the driver of the transportation vehicle wants automatic activation of a trailer coupling assistant of the transportation vehicle in response to the driver looking at the display device, which provides longitudinal and/or transverse guidance of the transportation vehicle to support the coupling maneuver, wherein automatic activation of the trailer coupling assistant occurs only in response to confirmation of the query.

### PRIORITY CLAIM

This patent application claims priority to German Patent Application No. 10 2018 214 973.9, filed 4 Sep. 2018, the disclosure of which is incorporated herein by reference in its entirety.

### SUMMARY

Illustrative embodiments relate to a method and a system for the automatic detection of a maneuver for coupling a transportation vehicle to a trailer. Furthermore, illustrative embodiments relate to a transportation vehicle with such a system.

### BRIEF DESCRIPTION OF THE DRAWINGS

Disclosed embodiments will be described in more detail below with reference to the single figure, in which:

FIG. 1 shows a schematic representation of a transportation vehicle and a trailer, wherein the transportation vehicle includes a system for the automatic detection of a maneuver for coupling the transportation vehicle to the trailer.

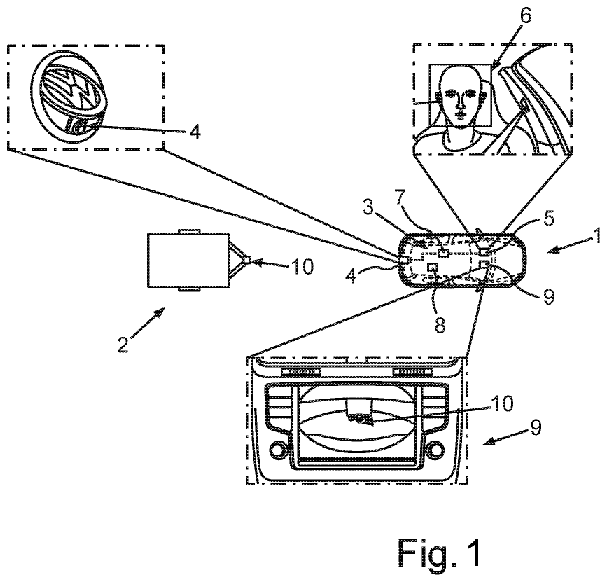

### DETAILED DESCRIPTION

A coupling maneuver to couple a trailer to a transportation vehicle is often a major challenge for many drivers. A trailer coupling of the trailer must be precisely met by a transportation vehicle's trailer coupling. However, the trailer coupling is usually not visible via the respective mirrors of the transportation vehicle and a view to the rear from a certain point.

Various systems are already known from the state of the art that can support a driver in a process of coupling to a trailer. For example, DE 10 2014 003 953 A1 reveals a coupling assistant that can assist a driver when coupling to a trailer by displaying a trajectory. For example, the driver can manually activate the coupling assistant. An automatic activation of the coupling assistant can also take place if the trailer is detected in the space to the rear of the transportation vehicle by the evaluation of video image material or, for example, a reverse gear has been engaged.

DE 10 2014 012 330 A1 reveals a driving assistance system as well as a method for performing a coupling process. In a video image, visible guide markings can be displayed for a driver as a bearing aid to make the coupling process easier for him. For example, the driving assistance system can be activated automatically as soon as a reverse gear has been engaged.

DE 10 2015 202 846 A1 describes a display of a transportation vehicle that can turn itself on or activate itself as soon as it is detected that a driver has directed his view to that display. The activated display, for example, allows an area to the rear of the transportation vehicle to be inserted for the driver.

DE 10 2016 122 916 A1 reveals a method for operating a trailer coupling assistant of a transportation vehicle. By one or more cameras, a coupling on the transportation vehicle and a trailer coupling on the trailer can be detected and displayed by a display in the transportation vehicle. After initiating a guided coupling process, a controller instructs the display to display the detected trailer couplings. The coupling process can be activated by selecting an option displayed on the display or by activating a button.

US 2015/0321666 A1 reveals a method for coupling a trailer to a transportation vehicle.

DE 10 2014 114 078 A1 reveals a method for coupling a trailer to a transportation vehicle. As soon as a driver has activated automatic towing positioning, the transportation vehicle drives towards the trailer autonomously.

Disclosed embodiments provide a solution by which a coupling maneuver for coupling a trailer is facilitated for a driver of a transportation vehicle.

This is achieved by a method and by a system for the automatic detection of a maneuver for coupling a transportation vehicle to a trailer.

In the disclosed method for the automatic detection of a maneuver for coupling a transportation vehicle to a trailer, a rear vehicle environment detected by a rear-view camera of the transportation vehicle displayed by a display device of the transportation vehicle. For example, this can be done automatically whenever a reverse gear of the transportation vehicle has been engaged. A viewing direction of a driver of the transportation vehicle that is recorded by a detection device of the transportation vehicle is used to determine whether the driver of the transportation vehicle is looking at the display device. If the driver is looking at the display device, a query is issued as to whether the driver of the transportation vehicle wishes to automatically activate a trailer coupling assistant of the transportation vehicle, which is designed to provide longitudinal and/or transverse guidance of the transportation vehicle to support the coupling maneuver, wherein automatic activation of the trailer coupling assistant is carried out only in the event of confirmation of the query.

It is therefore proposed to use viewing direction detection or so-called eye-tracking to detect the driver's intention, namely to determine whether the driver of the transportation vehicle currently intends to perform a coupling maneuver to couple the transportation vehicle to a trailer. An offer of assistance with regard to the activation of the trailer coupling assistant, which is designed to take over the longitudinal and/or transverse guidance of the transportation vehicle in support of the coupling maneuver, may be significantly improved by the disclosed method.

An offer of assistance, i.e., the issuing of the mentioned query as to whether the driver of the transportation vehicle wants automatic activation of the trailer coupling assistant, is only made in the appropriate situation. In addition, the activation of the trailer coupling assistant is facilitated, since the driver no longer has to perform the activation himself via an operating chain, but only has to accept the offer of assistance provided as an issued query. This can be of great benefit, especially for difficult driving tasks, as in these situations the driver is already busy with the actual handling of the transportation vehicle. The activation of the trailer coupling assistant can be seen as an additional load rather than a help, especially in such situations. By the disclosed method, on the other hand, it can be easily determined by viewing direction monitoring whether the driver wants to carry out a coupling maneuver for coupling the transportation vehicle to a trailer, wherein in this case the mentioned query is issued and as soon as the driver has confirmed this query the transportation vehicle's coupling assistant is automatically activated.

An exemplary embodiment provides that the query is issued only if the trailer is detected within the rear vehicle environment of the trailer. This can be used to ensure that issuing the mentioned query as to whether the driver of the transportation vehicle wants the automatic activation of the trailer coupling assistant only takes place in appropriate situations. If there is no trailer inside the rear vehicle environment, even if the driver is looking at the display device by which the area to the rear of the transportation vehicle is displayed, it can be assumed that the driver does not want to perform a maneuver for coupling to a trailer at this time.

A further exemplary embodiment provides that the query is issued only if the trailer is detected in the rear vehicle environment in a driving path of the transportation vehicle. For example, the driving path may be the area that can be monitored by the rear sensors of the transportation vehicle when the trailer coupling assistant is active. The path may also be the area in which the transportation vehicle would be travelling at the steering angle currently being used if the driver opens the throttle. If the trailer is detected inside the path, it is highly likely that the driver is planning a coupling maneuver if he is also looking at the display device by which the rear vehicle environment is displayed.

According to a further exemplary embodiment, it is provided that the trailer is detected in the rear vehicle environment by the rear camera, an ultrasonic sensor, a radar sensor and/or a laser sensor. The detection or additional validation of data supplied by machine vision by the rear-view camera, the ultrasonic sensor, the radar sensor and/or the laser sensor is therefore conceivable. The check of whether the trailer is in the rear vehicle environment can therefore be determined by various sensors on the transportation vehicle. In this way, it is possible to determine in a reliable manner whether there is a trailer in the area to the rear of the transportation vehicle at all, wherein the mentioned issuing of the query as to whether the driver of the transportation vehicle wants automatic activation of the trailer coupling assistant is also carried out only in this case, provided that the driver is also looking at the display device by which the area to the rear of the transportation vehicle, i.e., the rear vehicle environment, is displayed.

In a further exemplary embodiment, it is provided that the query is issued only if it is determined on the basis of the detected viewing direction of the driver that the driver is increasingly looking at the trailer coupling of the trailer that is being displayed by the display device. The disclosure is based on the realization that the driver can no longer see the trailer coupling of the trailer—at least from a certain proximity to the trailer—via the rear-view mirror or directly, but only by the display device. By checking whether the driver is looking at the trailer coupling, which is indicated by the display device, it can be reliably determined whether the driver even intends to perform a coupling maneuver. A check is therefore carried out as to whether the driver is looking at the image points of the display device by which the trailer coupling of the trailer is displayed.

A further exemplary embodiment provides that the query is issued only if it is determined on the basis of the detected viewing direction of the driver that the driver has looked more and more at the display device. The disclosure is based in this context on the realization that the driver will usually look at the display device again and again when he is preparing to drive to the trailer in reverse to couple the transportation vehicle. It is also possible to check how long the driver has consistently focused his gaze on the display device, wherein the query is issued only when he has exceeded a predetermined viewing time. This can also be carried out in combination with checking whether the driver has increasingly looked at the display device. In both cases, and also in combination, it is possible to determine reliably whether the driver actually intends to carry out a coupling maneuver.

In a further exemplary embodiment it is provided that the query is issued only if at least one steering correction by the driver has been detected after he has looked at the display device. In general, therefore, a steering angle can be produced to refine the detection of the driver's intention with a view to a possible coupling process. If the steering angle is used and the driver notices when looking at the display device that he is missing the trailer coupling of the trailer with the current trajectory and then initiates steering corrections, the probability of a coupling maneuver increases. If the driver sees by looking at the display device that with his current trajectory the trailer drawbar will not be met by the trailer coupling, he will perform a steering motion that brings it to the desired trajectory. By monitoring whether such a steering correction is carried out by the driver, it can be reliably determined whether the driver is actually intending to perform a coupling maneuver.

According to a further exemplary embodiment, it is provided that the viewing direction is detected by an interior camera of the detection device. As a result, the driver's viewing direction can be detected reliably. In addition to the interior camera, other sensors can also be used for viewing direction detection. The interior camera may be disposed, for example, in the vicinity of a steering wheel, a rear-view mirror or in the vicinity of the mentioned display device. Other sensors instead of or in addition to the interior camera are also conceivable to reliably detect the viewing direction of the driver.

The disclosed system for the automatic detection of a maneuver for coupling a transportation vehicle to a trailer includes a rear-view camera for detecting a rear vehicle environment of the transportation vehicle, a detection device for detecting a viewing direction of a driver of the transportation vehicle and a control device, which are set up to perform the disclosed method or an exemplary embodiment of the disclosed method. Exemplary embodiments of the disclosed method are to be regarded as exemplary embodiments of the disclosed system and vice versa, wherein the system comprises a method or mechanism for carrying out the method.

The disclosed transportation vehicle comprises the disclosed system or an exemplary embodiment of the disclosed system.

Further features and details result from the following description of an exemplary embodiment as well as on the basis of the drawing. The characteristics and combinations of features mentioned above in the description as well as the characteristics and combinations of features shown below in the description of the figure and/or in the figure alone can be used not only in the respective given combination, but also in other combinations or on their own without departing from the scope of the disclosure.

A transportation vehicle 1 and a trailer 2 are shown in a schematic representation in the only figure. The transportation vehicle 1 comprises a system 3 for the automatic detection of a maneuver for coupling the transportation vehicle 1 to a trailer 2. The system 3 includes a rear-view camera 4 for detecting a rear vehicle environment of a transportation vehicle 1, a detection device 5 for detecting a viewing direction of a driver 6 of the transportation vehicle 1 and a control device 7 that is arranged to evaluate sensor data from the rear-view camera 4 and the detection device 5 and, depending thereon, to activate a trailer coupling assistant 8 that is designed to conduct longitudinal and/or transverse guidance of transportation vehicle 1 to assist the driver 6 during a maneuver to couple to the trailer 2.

In the following, a method for the automatic detection of a maneuver for coupling the transportation vehicle 1 to the trailer 2 is described in more detail. For example, as soon as the driver 6 has engaged a reverse gear of the transportation vehicle 1, a rear vehicle environment of the transportation vehicle 1 is detected by the rear-view camera 4 and is displayed by a display device 9 of the transportation vehicle 1. The display device 9 can be located, for example, in the region of a center console of the transportation vehicle 1.

By the detection device 5, a viewing direction of the driver 6 is detected and using this it is determined whether the driver 6 is looking at the display device 9 by which the rear vehicle environment is displayed. If the driver 6 should be looking at the display device 9, issuing a query as to whether the driver 6 wants automatic activation of the trailer coupling assistant 8 is initiated by the control device 7. Only in the case of confirmation of this query by the driver 6, automatic activation of the trailer coupling assistant 8, by which the driver 6 can be partially automatically or fully automatically assisted when coupling to the trailer 2, is carried out so trailer coupling of the transportation vehicle 1 that is not shown in detail here can be positioned precisely on a trailer coupling 10 of the trailer 2 by appropriate control of the transportation vehicle 1.

It may be provided that the driver's 6 viewing attention to the display device 9 alone is not sufficient to issue the mentioned query as to whether the driver 6 wants automatic activation of the trailer coupling assistant 8. For example, the query can be issued audibly and/or visually. It may be provided that the query is only issued if the trailer 2 is actually detected within the detected rear vehicle environment. In addition, it may also be provided that the query is only issued if the trailer 2 is detected in a driving path in the rear vehicle environment. The trailer 2 can be detected by the rear-view camera 4 and/or also by ultrasonic sensors, radar sensors and/or laser sensors of the transportation vehicle 1. The detection or additional validation of the trailer 2 can therefore be carried out by various sensors of the transportation vehicle 1.

In addition, it may also be provided that the query is issued only if it is determined on the basis of the detected viewing direction of the driver 6 that the driver is looking at the trailer coupling 10 of the trailer 2 being displayed by the display device 9. It is to be assumed that if he should actually intend a coupling maneuver, the driver 6 will focus his view on the trailer coupling 10 of the trailer 2 displayed by the display device 9. It is also quite likely that the driver 6 will focus his eyes on the display device 9 multiple times. In this context, it may be provided that the mentioned query is issued only if it is determined using the detected viewing direction of the driver 6 that the driver has increasingly looked at the display device 9.

In addition, it is also possible for a steering angle of the transportation vehicle 1 to be monitored, for example, wherein the query is issued only if at least one steering correction by the driver 6 has been detected. If the steering angle is used and the driver 6 notices when looking at the display device 9 that he will miss the trailer coupling 10 of the trailer 2 with the current trajectory and then initiates corrections, the probability increases that the driver 6 actually wants to perform a coupling maneuver.

The installation position of the detection device 5 can be decisive for determining the viewing direction of the driver 6. For example, an interior camera, which may be part of the detection device 5, may be disposed, for example, in the vicinity of a steering wheel, a rear-view mirror or the display device 9 to detect the viewing direction of the driver 6 reliably and to be able to determine whether the driver is looking at the display device 9.

All in all, it is possible to reliably detect a maneuver for coupling a transportation vehicle 1 to a trailer 2 that is planned by the driver 6 by the described system 3 and method. An offer of assistance with regard to the automatic activation of the trailer coupling assistant 8 can thus be made reliably and accurately matching the situation if the driver 6 actually wants to perform a maneuver for coupling to the trailer 2.

### REFERENCE CHARACTER LIST

1 Transportation vehicle
2 Trailer
3 System
4 Reversing camera
5 Detection device
6 Driver
7 Control device
8 Trailer coupling assistant
9 Display device
10 Trailer coupling of the trailer

1. A system for the automatic detection of a maneuver for coupling a transportation vehicle to a trailer, the system comprising:
a rear-view camera for detecting a rear vehicle environment of the transportation vehicle;
a detection device for detecting the viewing direction of a driver of the transportation vehicle; and
a control device,
wherein the rear-view camera, detection device and control device carry out operations for the automatic detection of maneuvers for coupling a transportation vehicle to a trailer that include displaying the rear vehicle environment detected by the rear-view camera of the transportation vehicle by a display device of the transportation vehicle, determining whether the driver is looking at the display device based on the viewing direction of the driver detected by the detection device, and issuing a query as to whether the driver wants automatic activation of a trailer coupling assistant for the transportation vehicle that provides longitudinal and/or transverse guidance of the transportation vehicle to support the coupling maneuver in response to the driver looking at the display device, wherein automatic activation of the trailer coupling assistant takes place only in response to receiving the driver's confirmation issued in response to the query.

2. A transportation vehicle that includes the system of claim 1.

3. The system of claim 1, wherein the query is only issued in response to the trailer being detected within the rear vehicle environment.

4. The system of claim 1, wherein the query is only issued in response to the trailer being detected in a driving path of the transportation vehicle in the rear vehicle environment.

5. The system of claim 1, wherein the trailer is detected in the rear vehicle environment by the rear-view camera, an ultrasonic sensor, a radar sensor and/or a laser sensor.

6. The system of claim 1, wherein the query is only issued in response to a determination that the driver is looking at a trailer coupling of the trailer displayed by the display device based on the detected viewing direction of the driver.

7. The system of claim 1, wherein the query is only issued in response to a determination that the driver has increasingly looked at the display device based on the detected viewing direction of the driver.

8. The system of claim 1, wherein the query is issued only in response to at least one steering correction by the driver being detected after the driver has looked at the display device.

9. The system of claim 1, wherein the viewing direction is detected by an interior camera of the detection device.

10. A method for the automatic detection of a maneuver for coupling a transportation vehicle to a trailer, the method comprising:
displaying a rear vehicle environment detected by a rear-view camera of the transportation vehicle by a display device of the transportation vehicle;
determining whether the driver is looking at the display device by using a viewing direction of a driver of the transportation vehicle that is detected by a detecting device of the transportation vehicle ; and
issuing a query as to whether the driver of the transportation vehicle wants automatic activation of a trailer coupling assistant of the transportation vehicle that provides longitudinal and/or transverse guidance of the transportation vehicle to support the coupling maneuver in response to the driver looking at the display device, wherein automatic activation of the trailer coupling assistant takes place only in response to receiving the driver's confirmation issued in response to the query.

11. The method of claim 10, wherein the query is only issued in response to the trailer being detected within the rear vehicle environment.

12. The method of claim 10, wherein the query is only issued in response to the trailer being detected in a driving path of the transportation vehicle in the rear vehicle environment.

13. The method of claim 10, wherein the trailer is detected in the rear vehicle environment by the rear-view camera, an ultrasonic sensor, a radar sensor and/or a laser sensor.

14. The method of claim 10, wherein the query is only issued in response to a determination that the driver is looking at a trailer coupling of the trailer displayed by the display device based on the detected viewing direction of the driver.

15. The method of claim 10, wherein the query is only issued in response to a determination that the driver has increasingly looked at the display device based on the detected viewing direction of the driver.

16. The method of claim 10, wherein the query is issued only in response to at least one steering correction by the driver being detected after the driver has looked at the display device.

17. The method of claim 10, wherein the viewing direction is detected by an interior camera of the detection device.
